(19) United States
(12) Patent Application Publication
(10) Pub. No.: US 2008/0038071 A1
(43) Pub. Date: Feb. 14, 2008

(54) Pneumatic conveyor for light weight particles

(75) Inventors: Cameron Dwight Bodie, Moose Jaw (CA); Jonathan Cartei, Regina (CA)

Correspondence Address: FROST BROWN TODD, LLC, 2200 PNC CENTER, 201 E. FIFTH STREET, CINCINNATI, OH, 45202, US

(73) Assignee: Brandt Industries Ltd.

(21) Appl. No.: 11/501,513

(22) Filed: Aug. 9, 2006

(51) Int. Cl. B65G 53/60

(52) U.S. Cl. 406/171

(57) ABSTRACT

A pneumatic conveyor apparatus includes a separation chamber with an input port in a wall thereof. A vacuum duct has an output end connected to the input port. An auger discharge conveyor has a lower auger intake opening in a bottom portion of the separation chamber. A suction device creates an air stream flowing from the intake end of the vacuum duct through the input port into the separation chamber, and out through an upper portion of the separation chamber. A housing connects the input port to a first portion of the auger intake opening, and a screen covers a second portion of the auger intake opening such that the air stream flows from the input port into the first portion of the auger intake opening and flows out of the second portion of the auger intake opening through the screen into the separation chamber.

This invention relates pneumatic conveyors and in particular to such a conveyor for use with light weight particles such as sunflower seeds.

### BACKGROUND OF THE INVENTION

Pneumatic conveyors are well known for conveying agricultural products, as well as many industrial and commercial products. A fan or blower is used to create a vacuum at an intake end of a duct such that an air stream is created flowing through the duct. Granular material is picked up at the intake and carried through the duct by the air stream and into a separation chamber where the air stream is expanded and the velocity thereof slows so that particles fall out of the air stream to the bottom of the chamber. The air flows out of an upper portion of the chamber and the particles are removed from the bottom of the chamber by an auger or the like. Such a pneumatic conveyor is disclosed for example in U.S. Pat. No. 4,881,855 to Rempel et al.

Where the particles are relatively dense, such as wheat seeds for example, the particles readily fall through the slowly moving air stream to the bottom of the chamber. Where the particles are less dense many particles will be maintained in the air stream and be carried out through the fan and exhaust. For example sunflower seeds comprise a meat portion loosely contained inside a hollow hull, such that the seeds are much less dense than wheat for example.

Using such pneumatic conveyors with light weight particles such as sunflower seeds is thus problematic as losses can be excessive.

### BRIEF SUMMARY OF THE INVENTION

It is an object of the present invention to provide a pneumatic conveyor that overcomes problems in the prior art.

In a first embodiment the present invention provides a pneumatic conveyor apparatus comprising a separation chamber having an input port in a wall thereof. A vacuum duct has an output end connected to the input port, and an intake end. An auger discharge conveyor has a lower auger intake opening in a bottom portion of the separation chamber, and the auger discharge conveyor extends upward to a discharge end. A suction device is operative to create an air stream flowing from the intake end of the vacuum duct through the input port into the separation chamber, and out through an upper portion of the separation chamber. A housing connects the input port to a first portion of the auger intake opening, and a screen covers a second portion of the auger intake opening such that the air stream flows from the input port into the first portion of the auger intake opening and flows out of the second portion of the auger intake opening through the screen into the separation chamber.

In a second embodiment the present invention provides, for use with a pneumatic conveyor comprising a separation chamber having an input port in a wall thereof; a vacuum duct having an output end connected to the input port, and an intake end; an auger discharge conveyor having a lower auger intake opening in a bottom portion of the separation chamber, the auger discharge conveyor extending upward to a discharge end; and a suction device operative to create an air stream flowing from the intake end of the vacuum duct through the input port into the separation chamber, and out through an upper portion of the separation chamber, a light particle kit apparatus. The apparatus comprises a housing attachable to the separation chamber to connect the input port to a first portion of the auger intake opening, and a screen attachable to cover a second portion of the auger intake opening such that the air stream flows from the input port into the first portion of the auger intake opening and flows out of the second portion of the auger intake opening through the screen into the separation chamber.

In a third embodiment the present invention provides, for use with a pneumatic conveyor comprising a separation chamber having an input port in a wall thereof; a vacuum duct having an output end connected to the input port, and an intake end; an auger discharge conveyor having a lower auger intake opening in a bottom portion of the separation chamber, the auger discharge conveyor extending upward to a discharge end; and a suction device operative to create an air stream flowing from the intake end of the vacuum duct through the input port into the separation chamber, and out through an upper portion of the separation chamber, a method of conveying light weight particles. The method comprises directing the air stream through a housing from the input port of the separation chamber to a first portion of the auger intake opening, and covering a second portion of the auger intake opening with a screen such that the air stream flows from the input port into the first portion of the auger intake opening and flows out of the second portion of the auger intake opening through the screen into the separation chamber and such that particles carried in the air stream are maintained in the auger discharge conveyor.

In a fourth embodiment the present invention provides a pneumatic conveyor apparatus comprising an auger discharge conveyor comprising an auger flight inside an auger tube, the auger tube having an auger input port in a lower end thereof and sloping upward from the lower end thereof to a discharge end. A vacuum duct has an output end connected to the auger input port, and an intake end. A vacuum port is located in the auger tube between the input port and the discharge end, and a screen covers the vacuum port. The screen is configured such that outer edges of the auger flight are located in proximity to the screen. A suction device is connected to the vacuum port and is operative to create an air stream flowing from the intake end of the vacuum duct through the auger input port into the auger tube, and out through the screen and the vacuum port. Particles carried in the air stream are blocked by the screen and are scraped off the screen by the auger flight and conveyed to the discharge end of the auger discharge conveyor.

Thus instead of being carried out through the exhaust and lost, light particles are separated from the air stream by a screen and are thus maintained in the discharge auger conveyor of the pneumatic conveyor and conveyed to the discharge thereof for further use as desired. A kit can be supplied for installation on existing pneumatic conveyor, or the necessary housing and screen can be built in when the conveyor is manufactured. For improved versatility, the housing and screen are readily removed for use as a conventional pneumatic conveyor with heavier particles.

### BRIEF DESCRIPTION OF THE DRAWING

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of a pneumatic conveyor of the prior art showing the path of light particles carried out through the exhaust;

FIG. 2 is a schematic rear view of the prior art pneumatic conveyor of FIG. 1 with a light weight particle kit of the present invention installed thereon;

FIG. 3 is a schematic perspective view of the separation chamber of the pneumatic conveyor of FIG. 1 the light weight particle kit installed thereon as in FIG. 2;

FIG. 4 is a schematic perspective view of the separation chamber of the pneumatic conveyor of FIG. 1 with the light weight particle kit of FIG. 2 shown as a separate article above its installed location;

FIG. 5 is a top view of the kit apparatus of FIG. 2 beside the intake opening of the auger discharge conveyor;

FIG. 6 is a schematic side view of an alternate apparatus of the invention;

FIG. 7 is a schematic perspective view of the lower end of the auger discharge conveyor of the apparatus of FIG. 6.

### DETAILED DESCRIPTION OF THE ILLUSTRATED EMBODIMENTS

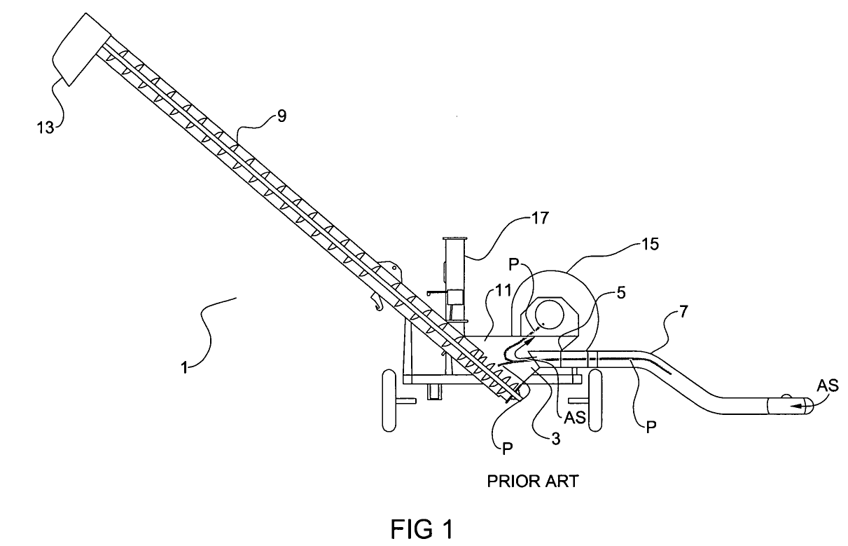

FIG. 1 illustrates a schematic rear view of a prior art pneumatic conveyor 1 comprising a separation chamber 3 having an input port 5 in one wall. A vacuum duct 7 has an output end connected to the input port 5, and an intake end An auger discharge conveyor 9 has a lower auger intake opening 11 in a bottom portion of the separation chamber 3. The auger discharge conveyor 9 extends upward to a discharge end 13. A suction device, illustrated as a fan 15 operative to create an air stream AS flowing from the intake end of the vacuum duct 7 through the input port 5 into the separation chamber 3, and out through an upper portion of the separation chamber to the intake of the fan 15.

In operation, when the air stream AS enters the separation chamber 3, it expands and slows dramatically, and the pneumatic conveyor 1 is configured so that the carried particles should drop out of the slowed air stream AS into the auger intake opening 11 and out through the auger discharge conveyor 9, and the air stream AS passes to the intake of the fan 15 and out through the exhaust 17. When conveying light weight particles P, as illustrated in FIG. 1, many of the particles P remain suspended in the air stream AS and are carried through the fan 15 and out the exhaust 17. Lightweight particles P, such as sunflower seeds, are not dense enough to fall through the slowly moving air stream AS into the intake opening 11 and so are carried out through the exhaust and lost. The proportion of lost seeds can be excessively high, such that the pneumatic conveyor cannot be used economically.

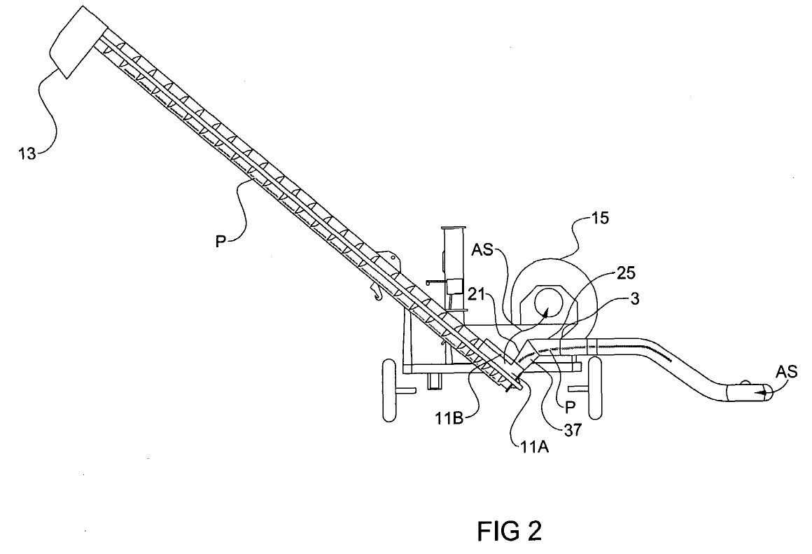

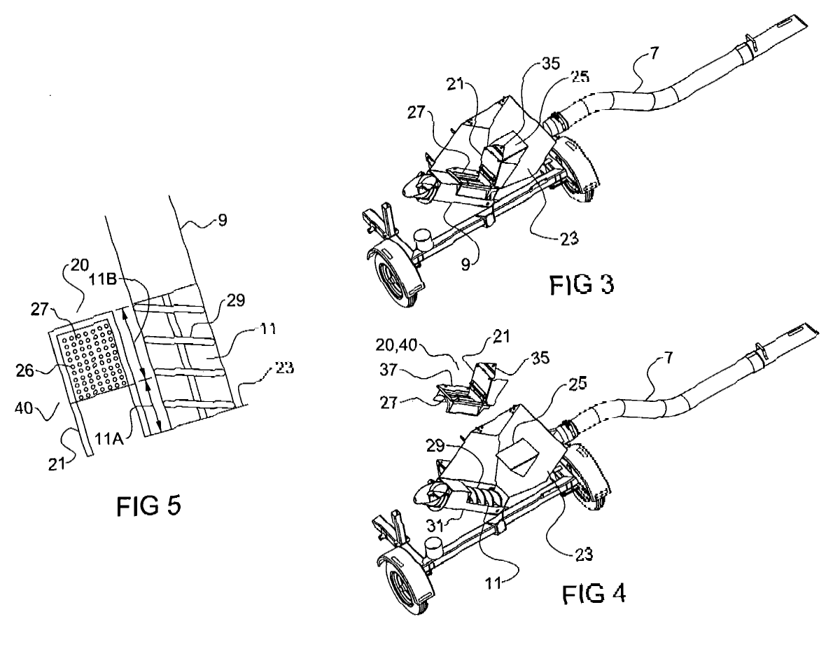

The present invention therefore provides, in one embodiment as illustrated in FIGS. 2-4, a light particle kit apparatus 20 for attachment to the prior art pneumatic conveyor 1. The kit apparatus 20 comprises a housing 21 attachable to the wall 23 of the separation chamber 3 to connect the input port 5 to a first portion 11A of the auger intake opening 11.

As illustrated in FIGS. 1-4, the prior art pneumatic conveyor 1 includes a shroud 25 extending from the wall 23 of the separation chamber 3 above the input port 5. This shroud 5 is designed to direct the air stream AS, and particles carried therein, well into the separation chamber 3 so that the particles have an opportunity to fall down into the auger intake opening 11 as the air stream slows in the chamber 3. Thus a direct flow from the input port 5 through the wall 23 to the intake of the fan 15 is prevented. The housing 21 is configured to attach to the shroud 25 and extend from the shroud 25 down along the wall 23 and cover the first portion 11A of the intake opening 11.

The kit apparatus 20 also comprises a screen 27 attachable to cover a second portion 11B of the auger intake opening 11 such that the air stream AS flows from the input port 5 into the first portion 11A of the auger intake opening 11 and then flows out of the second portion 11B of the auger intake opening 11 through the screen 27 into the separation chamber 3 and out through the fan 15. The holes 26 in the screen 27, as illustrated in FIG. 5, are sized to prevent light weight particles P from passing through the screen 27, and so the particles P are maintained in the discharge auger conveyor 9 and are conveyed to the discharge 13 thereof.

The screen is attached in proximity to outer edges of the auger flight 29 of the discharge auger conveyor 9 such that particles P carried in the air stream AS are scraped off the screen 27 by the auger flight 29, and thus prevented from being held against the screen 27 and blocking the air stream AS. In the illustrated embodiment the screen 27 conveniently forms a semi-cylindrical cover over the second portion 11A of the auger intake opening 11, the semi-cylindrical cover having a radius substantially the same as that of the auger flight 29 such that the two can be placed in close proximity.

The auger intake opening 11 comprises an opening in an auger tube 31 enclosing the auger flight 29 such that the auger intake opening 11 has a lower end adjacent a bottom end of the auger flight 29 and an upper end. The first portion 11A of the auger intake opening 11 is adjacent to the lower end of the auger intake opening 11 such that particles P in the air stream AS first flow into the lower end of the intake opening 11, and then are conveyed by rotation of the auger flight 29 and by flow of the air stream AS up past the screen 27 covering the second portion 11B in the upper end of the auger intake opening 11, where the air stream AS exits into the separation chamber 3 while the particles P are prevented from doing so by the screen 27, and so the particles P continue up the discharge auger conveyor 9.

In the illustrated embodiment the housing 21 is attached to the wall 23 of the separation chamber 3 by attachment of a top flange 35 to the shroud 25 such that a channel 37 from the input port 5 to the first portion 11A of the auger intake opening 11 is formed between the housing 21 and the wall 23 of the separation chamber 3. Side flanges 37 adjacent to the screen 27 can be attached with screws or the like to adjacent portions of the chamber 3. The illustrated kit apparatus 20 is thus configured as a single housing and screen assembly 40 that is relatively simple and quick to install, and that can likewise be removed to allow conventional operation of the pneumatic conveyor with heavier particles. The illustrated kit apparatus 20 is designed to fit the illustrated pneumatic conveyor 1. Those skilled in the art will readily adapt the kit apparatus to suit other designs and configurations of pneumatic conveyors.

The invention thus provides a method of conveying light weight particles P through a pneumatic conveyor 1 by directing the air stream AS through a housing 21 from the input port 5 of the separation chamber 3 to a first portion 11A of the auger intake opening 11, and covering the second portion 11B of the auger intake opening 11 with a screen 21 such that the air stream AS flows from the input port 5 into the first portion 11A of the auger intake opening 11 and flows out of the second portion 11B of the auger intake opening 11 through the screen 27 into the separation chamber 3, and such that particles P carried in the air stream AS are maintained in the auger discharge conveyor 9.

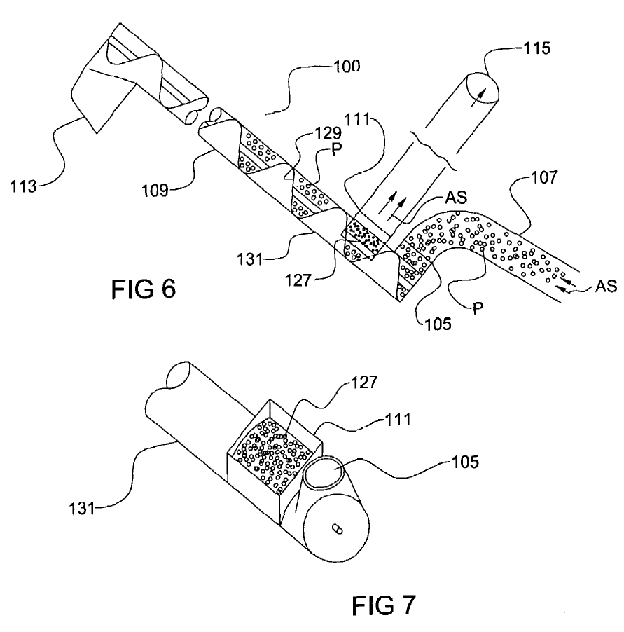

FIGS. 6 and 7 schematically illustrate an alternate embodiment of the invention, a pneumatic conveyor apparatus 100 that could be used where light weight particles will be conveyed. The apparatus 100 comprises an auger discharge conveyor 109 comprising an auger flight 129 inside an auger tube 131. The auger tube 131 has an auger input port 105 in a lower end thereof and the auger tube 131 slopes upward from the lower end to a discharge end 113. A vacuum duct 107 has an output end connected to the auger input port 105, and an opposite intake end.

A vacuum port 111 is located in the auger tube 131 between the input port 105 and the discharge end 113, and a screen 127 covering the vacuum port 111. The screen 127 is configured such that outer edges of the auger flight 129 are located in proximity to the screen 127.

A suction device 115 is connected to the vacuum port 111 and is operative to create an air stream AS flowing from the intake end of the vacuum duct 107 through the auger input port 105 into the auger tube 131, and out through the screen and the vacuum port. In the illustrated apparatus 100 the vacuum port 111 is adjacent to the input port 105 where the distance traveled by the air stream AS through the tube 131 is minimized.

In the illustrated embodiment the screen 127 forms a semi-cylindrical cover over the vacuum port 111, the semi-cylindrical cover having a radius substantially the same as that of the auger flight 129. Thus the particles P carried in the air stream AS are blocked by the screen 127, and are scraped off the screen 127 by the auger flight 129 and conveyed up the auger discharge conveyor 109 to the discharge end 113.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A pneumatic conveyor apparatus comprising:
a separation chamber having an input port in a wall thereof;
a vacuum duct having an output end connected to the input port, and an intake end;
an auger discharge conveyor having a lower auger intake opening in a bottom portion of the separation chamber, the auger discharge conveyor extending upward to a discharge end;
a suction device operative to create an air stream flowing from the intake end of the vacuum duct through the input port into the separation chamber, and out through an upper portion of the separation chamber;
a housing connecting the input port to a first portion of the auger intake opening, and a screen covering a second portion of the auger intake opening;
wherein the air stream flows from the input port into the first portion of the auger intake opening and flows out of the second portion of the auger intake opening through the screen into the separation chamber.

2. The apparatus of claim 1 wherein the screen is positioned in proximity to outer edges of an auger flight of the discharge auger conveyor such that particles carried in the air stream are scraped off the screen by the auger flight.

3. The apparatus of claim 2 wherein the screen forms a semi-cylindrical cover over the second portion of the auger intake opening, the semi-cylindrical cover having a radius substantially the same as that of the auger flight.

4. The apparatus of claim 2 wherein the auger intake opening comprises an opening in an auger tube enclosing the auger flight such that the auger intake opening has a lower end adjacent a bottom end of the auger flight and an upper end, and wherein the first portion of the auger intake opening is adjacent to the lower end of the auger intake opening and the second portion of the auger intake opening is adjacent to the upper end of the auger intake opening.

5. For use with a pneumatic conveyor comprising a separation chamber having an input port in a wall thereof; a vacuum duct having an output end connected to the input port, and an intake end; an auger discharge conveyor having a lower auger intake opening in a bottom portion of the separation chamber, the auger discharge conveyor extending upward to a discharge end; and a suction device operative to create an air stream flowing from the intake end of the vacuum duct through the input port into the separation chamber, and out through an upper portion of the separation chamber, a light particle kit apparatus comprising:
a housing attachable to the separation chamber to connect the input port to a first portion of the auger intake opening; and
a screen attachable to cover a second portion of the auger intake opening such that the air stream flows from the input port into the first portion of the auger intake opening and flows out of the second portion of the auger intake opening through the screen into the separation chamber.

6. The apparatus of claim 5 wherein the screen is attachable in proximity to outer edges of an auger flight of the discharge auger conveyor such that particles carried in the air stream are scraped off the screen by the auger flight.

7. The apparatus of claim 6 wherein the screen forms a semi-cylindrical cover over the second portion of the auger intake opening, the semi-cylindrical cover having a radius substantially the same as that of the auger flight.

8. The apparatus of claim 6 wherein the auger intake opening comprises an opening in an auger tube enclosing the auger flight such that the auger intake opening has a lower end adjacent a bottom end of the auger flight and an upper end, and wherein the first portion of the auger intake opening is adjacent to the lower end of the auger intake opening and the second portion of the auger intake opening is adjacent to the upper end of the auger intake opening.

9. The apparatus of claim 8 wherein the housing is attachable to a wall of the separation chamber such a channel from the input port to the first portion of the auger intake opening is formed between the housing and the wall of the separation chamber.

10. For use with a pneumatic conveyor comprising a separation chamber having an input port in a wall thereof; a vacuum duct having an output end connected to the input port, and an intake end; an auger discharge conveyor having a lower auger intake opening in a bottom portion of the separation chamber, the auger discharge conveyor extending upward to a discharge end; and a suction device operative to create an air stream flowing from the intake end of the vacuum duct through the input port into the separation chamber, and out through an upper portion of the separation chamber, a method of conveying light weight particles, the method comprising:
directing the air stream through a housing from the input port of the separation chamber to a first portion of the auger intake opening; and
covering a second portion of the auger intake opening with a screen such that the air stream flows from the input port into the first portion of the auger intake opening and flows out of the second portion of the auger intake opening through the screen into the separation chamber and such that particles carried in the air stream are maintained in the auger discharge conveyor.

11. The method of claim 10 wherein the screen is positioned in proximity to outer edges of an auger flight of the discharge auger conveyor such that particles carried in the air stream are scraped off the screen by the auger flight.

12. The method of claim 11 wherein the screen forms a semi-cylindrical cover over the second portion of the auger intake opening, the semi-cylindrical cover having a radius substantially the same as that of the auger flight.

13. The method of claim 11 wherein the auger intake opening comprises an opening in an auger tube enclosing the auger flight such that the auger intake opening has a lower end adjacent a bottom end of the auger flight and an upper end, and wherein the first portion of the auger intake opening is adjacent to the lower end of the auger intake opening and the second portion of the auger intake opening is adjacent to the upper end of the auger intake opening.

14. The method of claim 10 wherein the housing is attached to a wall of the separation chamber such that a channel from the input port to the first portion of the auger intake opening is formed between the housing and the wall of the separation chamber.

15. A pneumatic conveyor apparatus comprising:
an auger discharge conveyor comprising an auger flight inside an auger tube, the auger tube having an auger input port in a lower end thereof and sloping upward from the lower end thereof to a discharge end;
a vacuum duct having an output end connected to the auger input port, and an intake end;
a vacuum port in the auger tube between the input port and the discharge end;
a screen covering the vacuum port, the screen configured such that outer edges of the auger flight are located in proximity to the screen;
a suction device connected to the vacuum port and operative to create an air stream flowing from the intake end of the vacuum duct through the auger input port into the auger tube, and out through the screen and the vacuum port;
wherein particles carried in the air stream are blocked by the screen and are scraped off the screen by the auger flight and conveyed to the discharge end of the auger discharge conveyor.

16. The apparatus of claim 15 wherein the screen forms a semi-cylindrical cover over the vacuum port, the semi-cylindrical cover having a radius substantially the same as that of the auger flight.
